(19) United States
(12) Patent Application Publication
(10) Pub. No.: US 2015/0011214 A1
(43) Pub. Date: Jan. 8, 2015

(54) CIRCUIT SWITCHED FALLBACK METHOD AND USER EQUIPMENT

(71) Applicant: Huawei Technologies Co., Ltd., Shenzhen (CN)

(72) Inventors: Xueli QU, Shanghai (CN); Jun LIU, Shanghai (CN); Chang WANG, Shanghai (CN); Xiaoxiao ZHENG, Shanghai (CN)

(21) Appl. No.: 14/326,147

(22) Filed: Jul. 8, 2014

(30) Foreign Application Priority Data
Jul. 8, 2013 (CN) 201310284337.5

(51) Int. Cl. H04W 36/00

(52) U.S. Cl. CPC H04W 36/0022
USPC 455/436

(57) ABSTRACT

Embodiments of the present invention provide a circuit switched fallback method and a user equipment. The method includes: sending a request message to an LTE network, where the request message is used for requesting a CS voice service from the LTE network, so that the LTE network sends a CS voice service fallback response message to a user equipment, where the CS voice service fallback response message is used for instructing the user equipment to perform CSFB from the LTE network to a GSM network; after the CS voice service fallback response message sent by the LTE network is received, acquiring a system message of a target cell in the GSM network; and camping on the target cell according to the system message and initiating a CS registration process according to the system message, to perform the CS voice service.

### CROSS-REFERENCE TO RELATED APPLICATION

This application claims priority to Chinese Patent Application No. 201310284337.5, filed on Jul. 8, 2013, which is hereby incorporated by reference in its entirety.

### TECHNICAL FIELD

The present invention relates to the field of communications, and in particular, to a circuit switched fallback method and a user equipment.

### BACKGROUND

A CSFB (Circuit Switched FallBack, circuit switched fallback) technology is a technology that uses a GSM (Global System for Mobile Communications, Global System for Mobile Communications) network to support a CS (Circuit Switched Domain, circuit switched domain) call within a coverage area of an LTE (Long Term Evolution, Long Term Evolution) network. A CSFB process enables all CS voice services of a user equipment in the LTE network to be transferred to the GSM network having a relatively low bandwidth, thereby saving a bandwidth resource of an operator.

In the prior art, after a user equipment in an LTE network initiates a voice call or receives a voice call, the LTE network makes, by using a manner of redirection or cell changing or switching, a CS voice service of the user equipment fall back to a GSM network. Before the user equipment camps on a cell in the GSM network, the user equipment needs to obtain from the GSM network system messages of the cell on which the user equipment is to camp: an SI1, an SI3, and an SI13. The user equipment then camps on the cell of the GSM network, initiates a CS registration process, and performs the CS voice service. Compared with that the user equipment directly initiates a voice call to a GSM network, initiates a CS registration process, and performs a CS voice service, the above-mentioned CS registration process requires a long delay and worsens user experience.

In the prior art, after the 3GPP (The 3rd Generation Partnership Project, The 3rd Generation Partnership Project) protocol is upgraded to the R9 version, when making, by using a manner such as redirection or cell changing or switching, a CS voice service fall back to a GSM network, an LTE network can deliver a system message of a cell of the GSM network to a user equipment. In this way, when the CS voice service of the user equipment falls back to the GSM network, the user equipment can directly initiate a CS registration process and perform the CS voice service without the need for receiving the system message of the cell again. This method reduces a delay but requires the 3GPP protocol to be upgraded to the R9 version, which increases the complexity of a network side and a user equipment side. In addition, even after the 3GPP protocol is upgraded to the R9 version, if the LTE network does not deliver complete system messages of the cell, the user equipment still needs to wait to receive system messages delivered by the GSM network, in which case a delay still exists.

### SUMMARY

Embodiments of the present invention provide a circuit switched fallback method and a user equipment, which can reduce a delay and improve user experience.

To achieve the foregoing objective, the following technical solutions are adopted in the embodiments of the present invention.

According to a first aspect, a method for optimizing a CSFB process is disclosed, including:
sending a request message to a Long Term Evolution LTE network, where the request message is used for requesting a circuit switched CS voice service from the LTE network, so that the LTE network sends a CS voice service fallback response message to a user equipment, where the CS voice service fallback response message is used for instructing the user equipment to perform circuit switched fallback CSFB from the LTE network to a Global System for Mobile Communications GSM network;
after the CS voice service fallback response message sent by the LTE network is received, acquiring a system message of a target cell in the GSM network, where the system message is an SI1 and an SI3 or the system message is an SI3; and
camping on the target cell according to the system message and initiating a CS registration process according to the system message, to perform the CS voice service.

In a first possible implementation manner, the after the CS voice service fallback response message sent by the LTE network is received, acquiring a system message of a target cell in the GSM network includes:
after the CS voice service fallback response message sent by the LTE network is received, waiting to receive the system message of the target cell delivered by the GSM network; and
receiving and reading the system message of the target cell delivered by the GSM network, so as to acquire the system message of the target cell in the GSM network.

In a second possible implementation manner, the system message is the SI1 and the SI3; and
the CS voice service fallback response message carries at least one of the following messages: the SI1 and the SI3.

In a third possible implementation manner, with reference to the second possible implementation manner, the CS voice service fallback response message carries one message of the SI1 and the SI3, and the after the CS voice service fallback response message sent by the LTE network is received, acquiring a system message of a target cell in the GSM network includes:
after the CS voice service fallback response message is received, waiting to receive the other message, which is delivered by the GSM network, of the SI1 and the SI3; and
receiving and reading the other message of the SI1 and the SI3, so as to acquire the system messages of the target cell in the GSM network.

In a fourth possible implementation manner, with reference to the first or third possible implementation manner, the method includes: in the process of waiting to receive the system message of the target cell delivered by the GSM network or waiting to receive the other message, which is delivered by the GSM network, of the SI1 and the SI3, if an S13 of the target cell is received, reading and storing the SI13 of the target cell; and in the process of performing the CS voice service, if a cell on which the user equipment camps is not switched, after the CS voice service is completed, initiating a PS registration process according to the SI13 of the target cell.

In a fifth possible implementation manner, with reference to the first or third possible implementation manner, the method includes: in the process of waiting to receive the system message of the target cell delivered by the GSM network or waiting to receive the other message, which is delivered by the GSM network, of the SI1 and the SI3, if an SI13 of the target cell is not received, after the CS voice service is completed, receiving an SI13 of a cell on which the user equipment currently camps; and
initiating a PS registration process according to the SI13 of the cell on which the user equipment currently camps.

In a sixth possible implementation manner, with reference to the second possible implementation manner, when the CS voice service fallback response message includes the system message of the target cell in the GSM network, the after the CS voice service fallback response message sent by the LTE network is received, acquiring a system message of a target cell in the GSM network includes:
after the CS voice service fallback response message is received, acquiring the system message of the target cell in the GSM network from the CS voice service fallback response message.

According to a second aspect, a user equipment is disclosed, including:
a sending unit, configured to send a request message to a Long Term Evolution LTE network, where the request message is used for requesting a circuit switched CS voice service from the LTE network, so that the LTE network sends a CS voice service fallback response message to the user equipment, where the CS voice service fallback response message is used for instructing the user equipment to perform circuit switched fallback CSFB from the LTE network to a Global System for Mobile Communications GSM network;
a receiving unit, configured to receive the CS voice service fallback response message sent by the LTE network;
an acquiring unit, configured to: after the receiving unit receives the CS voice service fallback response message sent by the LTE network, acquire a system message of a target cell delivered by the GSM network, where the system message is an SI1 and an SI3 or the system message is an SI3; and
a processing unit, configured to camp on the target cell according to the system message acquired by the acquiring unit, and initiate a CS registration process according to the system message, to perform the CS voice service.

In a first possible implementation manner, the acquiring unit includes: a waiting subunit and an acquiring subunit, where:
the acquiring unit includes: a waiting subunit and an acquiring subunit, where: the waiting subunit is configured to: after the receiving unit receives the CS voice service fallback response message sent by the LTE network, wait to receive the system message of the target cell delivered by the GSM network; and
   the acquiring subunit is configured to receive and read the system message of the target cell delivered by the GSM network, so as to acquire the system message of the target cell in the GSM network.

In a second possible implementation manner, the system message is the SI1 and the SI3; and
the CS voice service fallback response message carries at least one of the following system message: the SI1 and the SI3.

In a third possible implementation manner, with reference to the second possible implementation manner, the CS voice service fallback response message carries one message of the SI1 and the SI3;
the waiting subunit is further configured to: after the CS voice service fallback response message is received, wait to receive the other message, which is delivered by the GSM network, of the SI1 and the SI3; and
the acquiring subunit is further configured to receive and read the other message of the SI1 and the SI3, so as to acquire the system message of the target cell in the GSM network.

In a fourth possible implementation manner, with reference to the first or third possible implementation manner, the acquiring subunit is further configured to: in the process of the waiting subunit waiting to receive the system message of the target cell delivered by the GSM network or waiting to receive the other message, which is delivered by the GSM network, of the SI1 and the SI3, receive and read an SI13 of the target cell, and then store the SI13 of the target cell; and
the processing unit is further configured to: if a cell on which the user equipment camps is not switched, after the CS voice service is completed, initiate a PS registration process according to the SI13 of the target cell acquired by the acquiring subunit.

In a fifth possible implementation manner, with reference to the first or third possible implementation manner, the acquiring subunit is further configured to: in the process of the waiting subunit waiting to receive the system message of the target cell delivered by the GSM network or waiting to receive the other message, which is delivered by the GSM network, of the SI1 and the SI3, if an SI13 of the target cell is not received, after the CS voice service is completed, receive and read an SI13 of a cell on which the user equipment currently camps; and
the processing unit is further configured to initiate a PS registration process according to the SI13, which is acquired by the acquiring subunit, of the cell on which the user equipment currently camps.

In a sixth possible implementation manner, with reference to the second possible implementation manner, the CS voice service fallback response message carries the system message of the target cell in the GSM network; and;
the acquiring unit is configured to: after the receiving unit receives the CS voice service fallback response message, acquire the system message of the target cell in the GSM network from the CS voice service fallback response message.

According to the circuit switched fallback method and the user equipment provided in the technical solutions, CS registration can be initiated after a system message (an SI1 and an SI3, or an SI3) is received, to perform a CS voice service, thereby reducing a delay compared with the prior art in which the SI1, the SI3, and the SI13 need to be received before initiating of CS registration.

### BRIEF DESCRIPTION OF DRAWINGS

FIG. 1 is a schematic flowchart of a circuit switched fallback method according to Embodiment 1 of the present invention;

FIG. 2 is a schematic flowchart of a circuit switched fallback method according to Embodiment 2 of the present invention;

FIG. 3 is a schematic flowchart of another circuit switched fallback method according to Embodiment 2 of the present invention;

FIG. 4 is a structural block diagram of a user equipment according to Embodiment 2 of the present invention;

FIG. 5 is a structural block diagram of another user equipment according to Embodiment 2 of the present invention; and

FIG. 6 is a structural block diagram of another user equipment according to Embodiment 2 of the present invention.

### DESCRIPTION OF EMBODIMENTS

The following describes in detail the method and apparatus provided by the embodiments of the present invention with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

There are three types of system message mentioned in this application: an SI1, an SI3, and an SI13.

The SI1 includes a cell channel description (Cell Channel Description), random access channel control parameters (RACH Control Parameters, Random Access Channel Control Parameters), and a band indicator (Band indicator). The cell channel description is used for informing a mobile station of an absolute channel number of a radio frequency channel used by a cell. The random access channel control parameters are used for providing RACH initialization and include: the maximum number of retransmissions for random access (Max retrains); the number of slots to spread retransmissions (Tx-integer) that is used for calculating a random access retransmission interval; cell bar access information (CELL_BAR_ACCESS); whether call re-establishment is allowed (RE); whether an emergency call is allowed (0 indicates that emergency calls from all mobile stations are allowed, and 1 indicates that only emergency calls from mobile stations of access classes 11-15 are allowed); and an access control class (Access Control Class N, N=0, 1, . . . 9, 11, . . . 15), where if a bit corresponding to ACC N is 0, it indicates that access of a mobile station of an access class N is allowed, and otherwise, it indicates that access is barred. The band indicator indicates whether a current cell is of a system of a band of 1800 or of a system of a band of 1900.

The SI3 includes a cell identity (Cell Identity), location area identification (Location Area Identification), a control channel description (Control Channel Description), cell options (Cell Options), cell reselection parameters (Cell Reselection Parameters), random access channel control parameters, and SI3 Rest Octet. The cell identity is a cell code and uniquely indicates a cell in a GSM PLMN (Public Land Mobile Network, public land mobile network). The location area identification: A coverage area of each GSM PLMN is divided into a great number of location areas, and a network number together with a location area code indicates a unique location area. The control channel description provides cell information, including: an MSC release (MSCR); IMSI Attach-Detach Allowed (ATT), used for notifying a mobile station of whether IMSI attachment and detachment processes are allowed in a cell; a common control channel configuration (CCCH-CONF), where a common control channel mainly includes an access grant channel (AGCH) and a paging channel (PCH), the CCCH-CONF indicates how many basic physical channels are used by the common control channel (CCCH) and whether the common control channel shares a physic channel with a stand-alone dedicated control channel (SDCCH), and the parameter decides the number of CCCH message blocks in a BCCH multiframe; the number of blocks reserved for access grant (BS-AG-BLKS-RES), indicating the number of blocks reserved for the AGCH channel in each broadcast control channel (BCCH) multiframe and actually used for allocating proportions of an AGCH and a PCH on a CCCH; cell bar qualify 3 (CBQ3), indicating whether an Iu mode is supported and whether a cell is barred; the number of paging channel multiframes (BS-PA-MFRMS), indicating the number of multiframes of a same paging group which cycle on a paging channel; and a length of time for periodical location area update (T 3212 time-out value). The cell options include: a power control indicator (PWRC); a discontinuous transmission indicator DTX; a radio link timeout (RADIO-LINK-TIMEOUT); and a dynamic frequency mapping indicator (DN-IND). The cell reselection parameters include: cell reselection hysteresis (CELL-RESELECT HYSTERESIS); a control channel maximum power level (MS-TXPWR-MAX-CCH); an attachment reselection parameter indicator (ACS), where cell selection and reselection of a mobile station rely on parameters C1 and C2, and the ACS is used for notifying the mobile station of whether the C2 is used during a cell reselection process; half-rate support (NECI); an minimum reception level of which access is allowed (RXLEV-ACCESS-MIN); random access channel control parameters, same as those in the description of the SI1 and not described repeatedly; and SI3 Rest Octet, including some additional cell reselection parameters and power parameters and indicating whether an SI2ter and an SI2quater exist and whether a GPRS and some other control parameters are supported.

The SI13 provides GPRS-related information of a cell, and a cell broadcasts an SI13 only when the cell supports a GPRS function.

### Embodiment 1

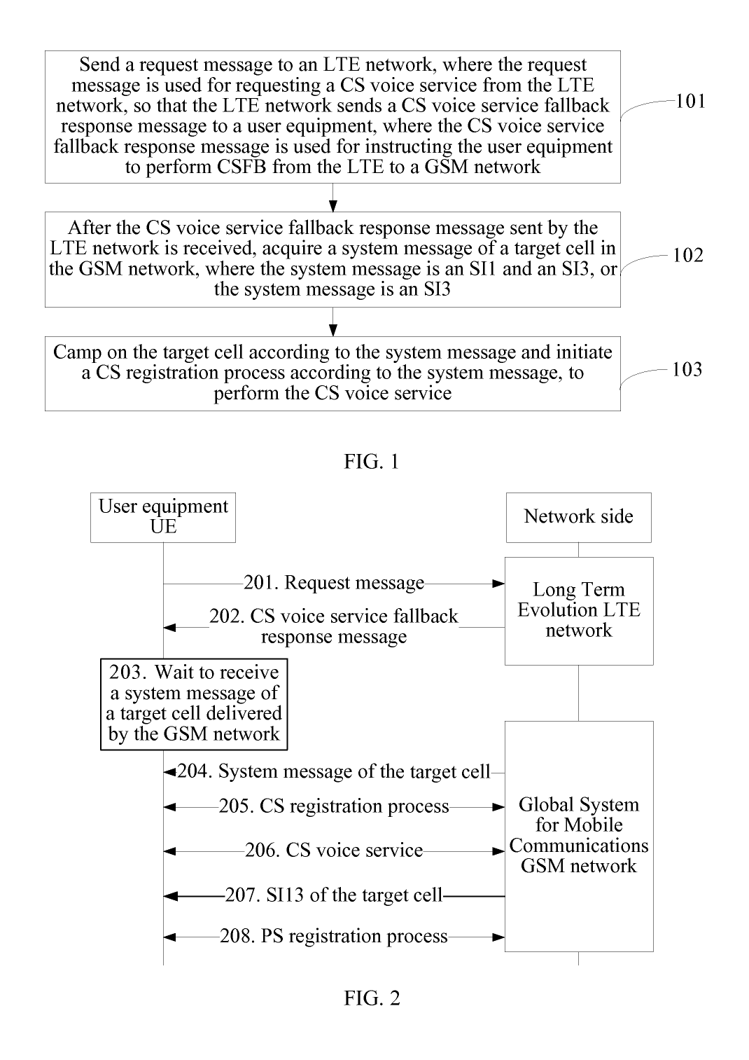

This embodiment of the present invention provides a circuit switched fallback method. As shown in FIG. 1, the method includes:

101: Send a request message to an LTE network, where the request message is used for requesting a CS voice service from the LTE network, so that the LTE network sends a CS voice service fallback response message to a user equipment, where the CS voice service fallback response message is used for instructing the user equipment to perform CSFB from the LTE network to a GSM network.

When a user equipment within coverage of the LTE network initiates the CS voice service such as initiating or receiving a call, the user equipment first sends, to the LTE network, a request message: Extend Service Request (ESR for short, extend service request), to request the CS voice service from the LTE network. After receiving the request, the LTE network makes, by using a manner of redirection or cell changing or switching, the CS voice service of the user equipment fall back to the GSM network. The LTE network then sends the CS voice service fallback response message to the user equipment, where the CS voice service fallback response message includes information such as a frequency and a band indicator of a target cell to which the CS voice service falls back in the GSM network, to instruct the user equipment to perform CSFB from the LTE network to the GSM network. The user equipment may find, according to the information such as the frequency and the band indicator, the target cell in the GSM network to which the user equipment is to fall back.

102: After the CS voice service fallback response message sent by the LTE network is received, acquire a system message of the target cell in the GSM network, where the system message is an SI1 and an SI3 or the system message is an SI3.

After the user equipment receives the CS voice service fallback response message sent by the LTE network and finds the target cell in the GSM network, the user equipment may interpret and acquire the system message when receiving the system message of the target cell.

It should be noted herein that the CS voice service fallback response message may carry all content of the system message, may carry a part of the content of the system message, and certainly may not carry the system message.

When the CS voice service fallback response message carries all of the system message, after finding the target cell, the user equipment reads the system message from the received CS voice service fallback response message; when the CS voice service fallback response message carries a part of the system message, the user equipment may receive the rest of the system message of the target cell from the GSM network; and when the CS voice service fallback response message does not carry the system message, the user equipment may receive all of the system message from the GSM network.

103: Camp on the target cell according to the system message and initiate a CS registration process according to the system message, to perform the CS voice service.

After receiving the system message, the user equipment immediately camps on the target cell according to the system message and initiates the CS registration process according to the system message, to perform the CS voice service.

In this embodiment of the present invention, the system message may be an SI1 and an SI3 or may be an SI3. According to a network communication protocol, a user equipment needs at most one TC period (1.9 s) to receive an SI1 and an SI3 or an SI3, but usually needs two TC periods (3.8 s) to receive an SI13, and even needs four TC periods (7.6 s) to receive an SI13 in an extreme scenario. The effect of receiving the SI13 is to provide necessary access information when PS registration is performed for accessing a GPRS, and the receiving of the SI13 does not affect the CS registration process. Therefore, during performing of the CS registration process, the user equipment only needs to receive the SI1 and the SI3, and does not need to receive the SI13.

Usually, the system message is the SI1 and the SI3. In this case, no matter whether the user equipment receives the SI13, as long as the user equipment acquires the SI1 and the SI, the user equipment immediately camps on the target cell and instantly initiates the CS registration process.

It should be noted herein that the system message may also include only the SI3. This case is only applicable to one application scenario, where within one TC period, the GSM network delivers only the SI3 to the user equipment. In this case, the user equipment does not know that the user equipment only needs to receive one message: the SI3. Therefore, the user equipment waits to receive the SI1 after receiving the SI3. If within one period, the user equipment fails to receive the SI1, the user equipment learns that the GSM network delivers only the SI3. At this time, no matter whether the user equipment obtains the SI13, as long as the user equipment acquires the SI3, the user equipment immediately camps on the target cell and instantly initiates the CS registration process, to perform the CS voice service.

As can be known from the foregoing, the circuit switched fallback method provided in this embodiment of the present invention, CS registration can be initiated after an SI1 and an SI3 or an SI3 is received, so as to perform a CS voice service, thereby reducing a delay compared with the prior art in which an SI1, an SI3, and an SI13 need to be received before CS registration is initiated.

### Embodiment 2

This embodiment of the present invention provides a circuit switched fallback method. In this method, a GSM network delivers all content of a system message. As shown in FIG. 2, the method includes:

201: A user equipment sends a request message to an LTE network, where the request message is used for requesting a CS voice service from the LTE network.

When a user equipment within coverage of the LTE network initiates the CS voice service such as initiating or receiving a call, the user equipment first sends, to the LTE network, a request message: Extend Service Request, to request the CS voice service from the LTE network.

202: The LTE network sends a CS voice service fallback response message to the user equipment, where the CS voice service fallback response message is used for instructing the user equipment to perform CSFB from the LTE network to a GSM network.

After receiving the request message, the LTE network, by using a manner of redirection or cell changing or switching, makes the CS voice service of the user equipment fall back to the GSM network. The LTE network then sends the CS voice service fallback response message to the user equipment, where the CS voice service fallback response message includes information such as a frequency and a band indicator of a target cell to which the CS voice service falls back in the GSM network, to instruct the user equipment to perform CSFB from the LTE network to the GSM network. The user equipment may find, according to the information such as the frequency and the band indicator, the target cell in the GSM network to which the user equipment is to fall back.

It should be noted herein that if the LTE network, by using the manner of redirection, makes the CS voice service of the user equipment fall back to the GSM network, the CS voice service fallback response message sent by the LTE network to the user equipment is an RRC Connection Release (Radio Resource Control Connection Release, radio resource control connection release); or if the LTE network, by using the manner of cell changing or switching, makes the CS voice service of the user equipment fall back to the GSM network, the CS voice service fallback response message sent by the LTE network to the user equipment is a MOBILITY From EUTRA Command (mobility from EUTRA command) (E-UTRA: Evolved Universal Terrestrial Radio Access, evolved universal terrestrial radio access).

203: After receiving the CS voice service fallback response message sent by the LTE network, the user equipment waits to receive a system message of the target cell delivered by the GSM network.

204: The user equipment receives and reads the system message of the target cell delivered by the GSM network, so as to acquire the system message of the target cell in the GSM network.

The system message may be an SI1 and an SI3 or may be an SI3.

In this case, the CS voice service fallback response message does not carry the system message, and the user equipment waits to receive the system message of the target cell sent by the GSM network. After the user equipment receives the system message of the target cell, because the user equipment already finds the target cell according to the information such as the frequency and the band indicator in the CS voice service fallback response message, the user equipment can read and acquire the system message of the target cell.

In step 203, in the process of the user equipment waiting to receive the system message of the target cell, if the user equipment receives an SI13, the user equipment acquires the SI1, the SI3, and the SI13 of the target cell within one TC period. Because the user equipment already finds the target cell, the user equipment decodes and reads the SI1, the SI3, and the SI13 of the target cell.

205: The user equipment camps on the target cell according to the system message and initiates a CS registration process according to the system message, to perform the CS voice service.

After reading the system message of the target cell, the user equipment immediately camps on the target cell and initiates a CS registration process to the GSM network.

In this embodiment of the present invention, as long as the user equipment acquires the system message of the target cell, the user equipment can camp on the target cell and initiate the CS registration process. The user equipment does not need to wait to receive the SI13, which reduces a delay.

206: The user equipment performs the CS voice service with the GSM network.

After completing registration with the GSM network, the user equipment performs the CS voice service with the GSM network.

207: After the CS voice service is completed, receive an SI13, which is delivered by the GSM network, of a cell on which the user equipment currently camps.

208: Perform a PS registration process.

If the user equipment does not acquire the SI13 of the target cell in step 203, the user equipment needs to receive the SI13, which is delivered by the GSM network, of the cell on which the user equipment currently camps, so as to initiate PS registration.

Certainly, if the cell on which the user equipment camps is switched, even if the user equipment stores the SI13 of the target cell in step 203, the user equipment still needs to wait to receive the SI13, which is delivered by the GSM network, of the cell on which the user equipment currently camps, so as to initiate the PS registration.

However, after the CS voice service is completed, if the cell on which the user equipment camps is not switched, and if the user equipment already acquires the SI13 of the target cell in step 203, the user equipment does not need to wait to receive the SI13 of the cell on which the user equipment currently camps and can directly initiate the PS registration process according to the SI13. Certainly, after the CS voice service is completed, if the user equipment receives a Channel Release message delivered by the GSM network, which instructs the user equipment to fall back to the LTE network, the user equipment may not need to wait to receive the SI13, and the user equipment camps back on the LTE network according to information indicated by the Channel Release.

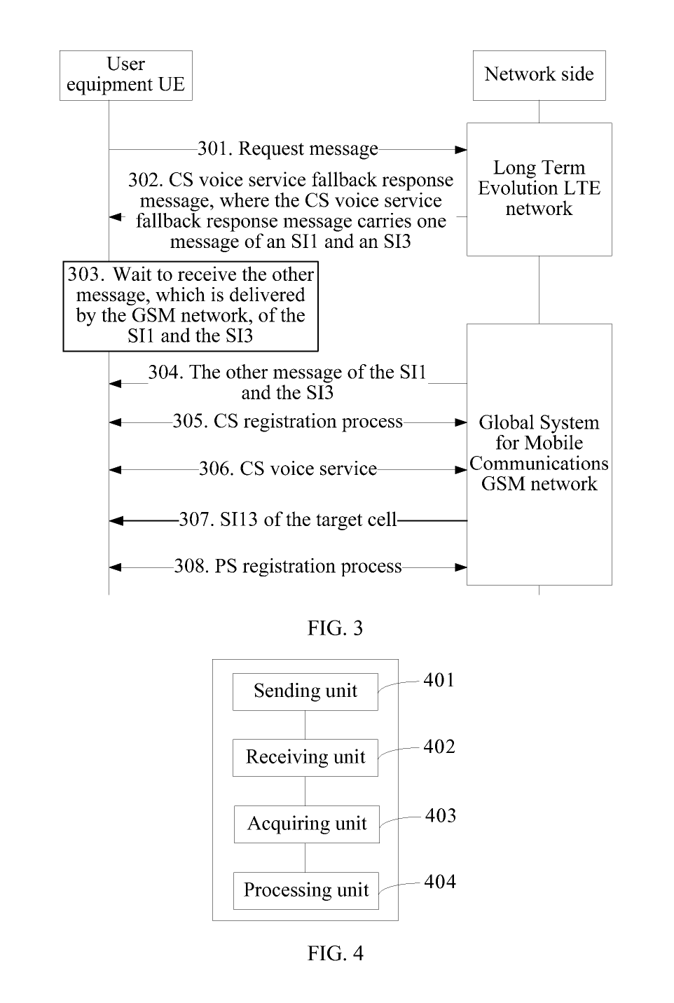

This embodiment of the present invention further provides a circuit switched fallback method. In this method, the system message is the SI1 and the SI3, and the LTE network delivers a part of content of the system message. As shown in FIG. 3, the method includes:

301: A user equipment sends a request message to an LTE network, where the request message is used for requesting a CS voice service from the LTE network.

When a user equipment within coverage of the LTE network initiates the CS voice service such as initiating or receiving a call, the user equipment first sends, to the LTE network, a request message: Extend Service Request, to request the CS voice service from the LTE network.

302: The LTE network sends a CS voice service fallback response message to the user equipment, where the CS voice service fallback response message is used for instructing the user equipment to perform CSFB from the LTE network to a GSM network.

After receiving the request message, the LTE network, by using a manner of redirection or cell changing or switching, makes the CS voice service of the user equipment fall back to the GSM network. The LTE network then sends the CS voice service fallback response message to the user equipment, where the CS voice service fallback response message includes information such as a frequency and a band indicator of a target cell to which the CS voice service falls back in the GSM network, to instruct the user equipment to perform CSFB from the LTE network to the GSM network. The user equipment may find, according to the information such as the frequency and the band indicator, the target cell in the GSM network to which the user equipment is to fall back.

The CS voice service fallback response message carries one message of an SI1 and an SI3.

303: After receiving the CS voice service fallback response message, the user equipment waits to receive the other message, which is delivered by the GSM network, of the SI1 and the SI3.

304: The user equipment receives and reads the other message of the SI1 and the SI3, so as to acquire the system message of the target cell in the GSM network.

The CS voice service fallback response message carries one message of the SI1 and the SI3; therefore, after finding the target cell, the user equipment reads and acquires one message of the SI1 and the SI3. The user equipment then waits to receive the other message, which is delivered by the GSM network, of the SI1 and the SI3. After receiving and reading the other message of the SI1 and the SI3, the user equipment obtains all content of the system message of the target cell in the GSM network.

It should be noted herein that in the process of the user equipment waiting to receive the other message, which is delivered by the GSM network, of the SI1 and the SI3, the user equipment may receive an SI13 of the target cell. In this case, the user equipment reads and stores the SI13 of the target cell.

305: The user equipment camps on the target cell according to the system message and initiates a CS registration process according to the system message, to perform the CS voice service.

After reading the system message of the target cell, the user equipment immediately camps on the target cell and initiates the CS registration process to the GSM network.

In this embodiment of the present invention, as long as the user equipment acquires the SI1 and the SI3 of the target cell, the user equipment can camp on the target cell and initiate the CS registration process. The user equipment does not need to wait to receive the SI13, which reduces a delay.

306: The user equipment performs the CS voice service with the GSM network.

After completing registration with the GSM network, the user equipment performs the CS voice service with the GSM network.

307: After the CS voice service is completed, receive an SI13, which is delivered by the GSM network, of a cell on which the user equipment currently camps.

308: Perform a PS registration process.

If the user equipment does not acquire the SI13 of the target cell in step 303, the user equipment needs to receive the SI13, which is delivered by the GSM network, of the cell on which the user equipment currently camps, so as to initiate PS registration.

Certainly, if the cell on which the user equipment camps is switched, the stored SI13 of the target cell is useless. In this case, same as that in the prior art, the user equipment needs to receive the SI13, which is delivered by a network side, of the cell on which the user equipment currently camps, so as to initiate the PS registration.

However, after the CS voice service is completed, if the cell on which the user equipment camps is not switched, and if the user equipment already acquires the SI13 of the target cell in step 303, the user equipment does not need to wait to receive the SI13 and can directly initiate the PS registration process according to the SI13. Certainly, after the CS voice service is completed, if the user equipment receives a Channel Release message delivered by the GSM network, which instructs the user equipment to fall back to the LTE network, the user equipment may not need to wait to receive the SI13, and the user equipment camps back on the LTE network according to information indicated by the Channel Release.

This embodiment of the present invention further provides a circuit switched fallback method. The method includes: sending, by a user equipment, a request message to an LTE network, so that the LTE network sends a CS voice service fallback response message to the user equipment, where the CS voice service fallback response message carries a system message of a target cell in a GSM network. In this case, after acquiring the system message, the user equipment does not need to wait to receive an SI13, and can immediately camp on the target cell and initiate a CS registration process, to perform a CS voice service.

The three methods according to Embodiment 2 have an effect of reducing a delay in some application scenarios in an existing network, which is specifically shown in Table 1.

TABLE 1

| The system message | The system message | The system message | |
|---|---|---|---|
| in the CS voice | needing to be acquired | needing to be acquired | |
| service fallback | and a delay before | and a delay after | Theoretical |
| response message | optimization | optimization | effect |
| No system message | SI1, SI3, and SI13 | SI1 and SB | Reduced by 0 |
| | (At most 4 TC periods) | (At most 1 TC period) | to 3 TC periods |
| SI1 | SB and SI13 | SB | Reduced by 0 |
| | (At most 4 TC periods) | (At most 1 TC period) | to 3 TC periods |
| SI3 | SI1 and SI13 | SI1 | Reduced by 0 |
| | (At most 4 TC periods) | (At most 1 TC period) | to 3 TC periods |
| SI1 and SI3 | SI13 | No need to start the | Reduced by 1 |
| | (At most 4 TC periods) | receiving of the | to 4 TC periods |
| | | system message | |

In a network supporting a GPRS, scenario 1: When no system message exists in the CS voice service fallback response message sent by the LTE network to the user equipment, in the prior art, the user equipment needs to receive the SI1, the SI3, and the SI13, which requires a delay of at most 4 TC periods; when the method in steps 201 to 207 of the present invention is used, the user equipment only needs to wait to receive the SI1 and the SI3, which requires a delay of at most 1 TC period; and compared with the prior art, the method provided in this embodiment of the present invention can reduce the delay by 0 to 3 TC periods. Scenario 2: When the system message SI1 exists in the CS voice service fallback response message sent by the LTE network to the user equipment, in the prior art, the user equipment needs to wait to receive the SI3 and the SI13, which requires a delay of at most 4 TC periods; when the method in steps 301 to 307 of the present invention is used, the user equipment only needs to receive the SI3, which requires a delay of at most 1 TC period; and compared with the prior art, the method provided in this embodiment of the present invention can reduce the delay by 0 to 3 TC periods. Scenario 3: When the system message SI3 exists in the CS voice service fallback response message sent by the LTE network to the user equipment, in the prior art, the user equipment needs to wait to receive the SI1 and the SI13, which requires a delay of at most 4 TC periods; when the method in steps 301 to 307 of the present invention is used, the user equipment only needs to wait to receive the SI1, which requires a delay of at most 1 TC period; and compared with the prior art, the method provided in this embodiment of the present invention can reduce the delay by 0 to 3 TC periods. Scenario 4: When the system message SI1 and SI3 exist in the CS voice service fallback response message sent by the network side to the user equipment, in the prior art, the user equipment needs to receive the SI13, which requires a delay of at most 4 TC periods; in the last method provided in this embodiment of the present invention, the user equipment does not need to receive the SI13; and compared with the prior art, the method provided in this embodiment of the present invention can reduce the delay by 1 to 4 TC periods.

It can be found by analyzing the foregoing scenarios that if the user equipment acquires, before camping on a cell G, only the SI1 and the SI3 or only the SI3, this can be completed usually within 1 s; however, if the user equipment also needs to acquire the SI13, the user equipment usually needs to wait for the second TC period, and it takes about 4 s to complete this. Therefore, the optimization effect of the method provided in this embodiment of the present invention is reducing the delay by 2 s to 3 s in the most typical scenario. According to the extreme scenario of the protocol, if it takes 4 TC periods to receive the SI13, the method provided in this embodiment of the present invention can reduce the delay by more than 6 s.

This embodiment of the present invention further provides a user equipment. As shown in FIG. 4, the user equipment includes: a sending unit 401, a receiving unit 402, an acquiring unit 403, and a processing unit 404.

The sending unit 401 is configured to send a request message to a Long Term Evolution LTE network, where the request message is used for requesting a circuit switched CS voice service from the LTE network, so that the LTE network sends a CS voice service fallback response message to the user equipment, where the CS voice service fallback response message is used for instructing the user equipment to perform circuit switched fallback CSFB from the LTE network to a Global System for Mobile Communications GSM network.

When a user equipment within coverage of the LTE network initiates the CS voice service such as initiating or receiving a call, the sending unit 401 of the user equipment first sends, to the LTE network, a request message: Extend Service Request, to request the CS voice service from the LTE network.

After receiving the request message, the LTE network, by using a manner of redirection or cell changing or switching, makes the CS voice service of the user equipment fall back to the GSM network. The LTE network then sends the CS voice service fallback response message to the user equipment, where the CS voice service fallback response message includes information such as a frequency and a band indicator of a target cell to which the CS voice service falls back in the GSM network, to instruct the user equipment to perform CSFB from the LTE network to the GSM network. The user equipment may find, according to the information such as the frequency and the band indicator, the target cell in the GSM network to which the user equipment is to fall back.

The receiving unit 402 is configured to receive the CS voice service fallback response message sent by the LTE network.

The acquiring unit 403 is configured to: after the receiving unit receives the CS voice service fallback response message sent by the LTE network, acquire a system message of a target cell delivered by the GSM network, where the system message is an SI1 and an SI3 or the system message is an SI3.

It should be noted herein that the CS voice service fallback response message may carry all content of the system message, may carry a part of the content of the system message, and certainly may not carry the system message.

The processing unit 404 is configured to camp on the target cell according to the system message acquired by the acquiring unit 403, and initiate a CS registration process according to the system message, to perform the CS voice service.

It should be noted herein that for a situation where the system message only includes the SI3, the situation is corresponding to the following application scenario: Within one TC period, the GSM network delivers only the SI3 to the user equipment. In this case, the user equipment does not know that the user equipment only needs to receive one message: the SI3. Therefore, the user equipment waits to receive the SI1 after receiving the SI3. The user equipment waits for only one TC period, and within the TC period, if the user equipment fails to receive the SI1, the user equipment learns that the GSM network delivers only the SI3. At this time, no matter whether the user equipment acquires the SI13, as long as the user equipment acquires the SI3, the user equipment immediately camps on the target cell and instantly initiates the CS registration process, to perform the CS voice service.

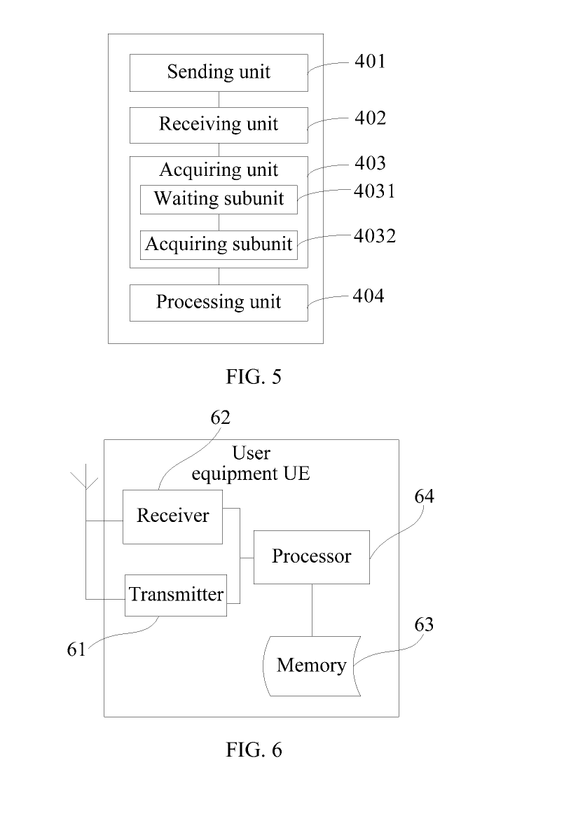

Optionally, as shown in FIG. 5, the acquiring unit 403 includes a waiting subunit 4031 and an acquiring subunit 4032.

If the CS voice service fallback response message does not carry the system message, the waiting subunit 4031 is configured to: after the receiving unit 402 receives the CS voice service fallback response message sent by the LTE network, wait to receive the system message of the target cell delivered by the GSM network; and the acquiring subunit 4032 is configured to receive and read the system message of the target cell delivered by the GSM network, so as to acquire the system message of the target cell in the GSM network.

In the process of the waiting subunit 4031 waiting to receive the system message of the target cell delivered by the GSM network, if the acquiring subunit 4032 receives and reads the SI13 of the target cell, the acquiring subunit 4032 stores the SI13 of the target cell; and if a cell on which the user equipment currently camps is not switched, after the CS voice service is completed, the processing unit 404 initiates a PS registration process according to the SI13 of the target cell acquired by the obtaining subunit 4032.

Alternatively, in the process of the waiting subunit 4031 waiting to receive the system message of the target cell delivered by the GSM network, if the acquiring subunit 4032 does not receive the SI13 of the target cell, after the CS voice service is completed, the acquiring subunit 4032 receives and reads an SI13 of a cell on which the user equipment currently camps; and the processing unit 404 is configured to initiate a PS registration process according to the SI13, which is acquired by the acquiring subunit 4032, of the cell on which the user equipment currently camps.

Optionally, if the system message is the SI1 and the SI3, the CS voice service fallback response message carries at least one of the following message: the SI1 and the SI3.

If the CS voice service fallback response message carries one message of the SI1 and the SI3, the waiting subunit 4031 is configured to: after the CS voice service fallback response message is received, wait to receive the other message, which is delivered by the GSM network, of the SI1 and the SI3; and the acquiring subunit 4032 is configured to receive and read the other message of the SI1 and the SI3, so as to acquire the SI1 and the SI3 of the target cell.

Further, in the process of waiting to receive the other message, which is delivered by the GSM network, of the SI1 and the SI3, the acquiring subunit 4032 receives and reads the SI13 of the target cell, and then stores the SI13 of the target cell; and if the cell on which the user equipment camps is not switched, after the CS voice service is completed, the processing unit 404 initiates the PS registration process according to the SI13 of the target cell acquired by the acquiring subunit 4032.

Alternatively, in the process of the waiting subunit 4031 waiting to receive the SI1 and the SI3 of the target cell delivered by the GSM network or waiting to receive the other message, which is delivered by the GSM network, of the SI1 and the SI3, if the acquiring subunit 4032 does not receive the SI13 of the target cell, after the CS voice service is completed, the acquiring subunit 4032 receives and reads an SI13 of a cell on which the user equipment currently camps; and the processing unit 404 is configured to initiate a PS registration process according to the SI13, which is acquired by the acquiring subunit 4032, of the cell on which the user equipment currently camps.

Certainly, in this embodiment of the present invention, the CS voice service fallback response message carries the system message of the target cell in the GSM network, and the acquiring unit 403 is therefore configured to: after the receiving unit 402 receives the CS voice service fallback response message, acquire the system message of the target cell in the GSM network from the CS voice service fallback response message.

For hardware implementation, the sending unit may be a transmitter or a transceiver, the receiving unit may be a receiver or a transceiver, and the sending unit and the receiving unit may be integrated to form a transceiver unit, which is a transceiver when implemented as hardware. The other units may be embedded into a processor of the user equipment in the form of hardware or software. The processor may be a central processing unit (CPU) or a single-chip microcomputer.

FIG. 6 is a schematic structural diagram of a user equipment according to this embodiment of the present invention. As shown in the figure, the user equipment includes a transmitter 61, a receiver 62, a memory 63, and a processor 64 which is separately connected to the transmitter 61, the receiver 62, and the memory 63. Certainly, the user equipment may further include general components, such as an antenna, a baseband processing component, a radio frequency processing component, and an input/output apparatus, and this embodiment of the present invention does not impose any limitation herein.

The memory 63 stores a set of program code, and the processor 64 is configured to call the program code stored in the memory 63 to execute the following operations:

The processor 64 may send a request message to an LTE network through the transmitter 61, where the request message is used for requesting a circuit switched CS voice service from the LTE network, so that the LTE network sends a CS voice service fallback response message to the user equipment, where the CS voice service fallback response message is used for instructing the user equipment to perform circuit switched fallback CSFB from the LTE network to a Global System for Mobile Communications GSM network, and then receive, by using the receiver 62, the CS voice service fallback response message sent by the LTE network; and after the processor 64 receives, by using the receiver 62, the CS voice service fallback response message sent by the LTE network, the processor 64 acquires a system message of a target cell in the GSM network, then camps on the target cell according to the acquired system message, and initiates a CS registration process according to the system message, to perform the CS voice service, where the system message includes an SI1 and an SI3 or the system message includes an SI3.

It should be noted herein that for a situation where the system message only includes the SI3, the situation is corresponding to the following application scenario: Within one TC period, the GSM network delivers only the SI3 to the user equipment. In this case, the user equipment does not know that the user equipment only needs to receive one message: the SI3. Therefore, the user equipment waits to receive the SI1 after receiving the SI3. The user equipment waits for only one TC period, and within the TC period, if the user equipment fails to receive the SI1, the user equipment learns that the GSM network delivers only the SI3. At this time, no matter whether the user equipment obtains the SI13, as long as the user equipment acquires the SI3, the user equipment immediately camps on the target cell and instantly initiates the CS registration process, to perform the CS voice service.

If the system message is to be delivered by the GSM network, after the receiver 62 receives the CS voice service fallback response message sent by the LTE network, the processor 64 waits to receive the system message of the target cell delivered by the GSM network, and receives and reads the system message of the target cell by using the receiver 62, so as to acquire the system message of the target cell.

Further, in the process of waiting to receive the system message delivered by the GSM network, if the processor 64 receives and reads an SI13 of the target cell, and then stores the SI13 of the target cell, and in the process of performing the CS voice service, if a cell on which the user equipment camps is not switched, after the CS voice service is completed, the processor 64 initiates a PS registration process according to the SI13 of the target cell.

In the process of waiting to receive the system message delivered by the GSM network, if the processor 64 does not receive an SI13 of the target cell, after the CS voice service is completed, the processor 64 receives, by using the receiver 62, an SI3 of a cell on which the user equipment currently camps, and initiates a PS registration process according to the SI13 of the cell on which the user equipment currently camps.

If the system message is the SI1 and the SI3, and is jointly delivered by the GSM network and the LTE network, the CS voice service fallback response message sent by the LTE network to the user equipment carries at least one of the following message: the SI1 and the SI3. After the receiver 62 receives the CS voice service fallback response message sent by the LTE network, the processor 64 waits to receive the other message, which is delivered by the GSM network, of the SI1 and the SI3; and the processor 64 receives and reads the other message of the SI1 and the SI3 by using the receiver 62, so as to acquire the SI1 and the SI3 of the target cell.

Further, in the process of waiting to receive the other message, which is delivered by the GSM network, of the SI1 and the SI3, if the processor 64 receives and reads an SI13 of the target cell, and then stores the SI13 of the target cell; and in the process of performing the CS voice service, if a cell on which the user equipment camps is not switched, after the CS voice service is completed, the processor 64 initiates a PS registration process according to the SI13 of the target cell.

In the process of waiting to receive the other message, which is delivered by the GSM network, of the SI1 and the SI3, if the processor 64 does not receive an SI13 of the target cell, after the CS voice service is completed, the processor 64 receives, by using the receiver 62, an SI13 of a cell on which the user equipment currently camps, and initiates a PS registration process according to the SI13 of the cell on which the user equipment currently camps.

If the system message is to be delivered by the LTE network, and the CS voice service fallback response message sent by the LTE network to the user equipment carries the system message, after acquiring the system message of the target cell in the GSM network from the CS voice service fallback response message, the processor 64 can immediately camp on the target cell and initiate the CS registration process, to perform the CS voice service.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A circuit-switched (CS) fallback (CSFB) method, comprising:
sending, by a user equipment, a request message to a Long Term Evolution (LTE) network, for requesting CS voice service from the LTE network
receiving, by the user equipment, a CS voice service fallback response message from the LTE network, for instructing the user equipment to perform CSFB from the LTE network to a Global System for Mobile Communications (GSM) network;
after the receiving, acquiring, by the user equipment, a system message of a target cell in the GSM network, wherein the system message comprises an SI3 message; and
camping by the user equipment, on the target cell according to the system message and initiating a CS registration process according to the system messages for performing the CS voice service.

2. The method according to claim 1, wherein acquiring the system message comprises:
waiting to receive the system message of the target cell delivered by the GSM network; and
receiving and reading the system message of the target cell from the GSM network.

3. The method according to claim 2, further comprising:
based on an SI13 message of the target cell being received during the waiting, reading and storing the SI13 message of the target cell; and
during performance of the CS voice service, based on a cell on which the user equipment camps not being switched, initiating a packet-switched (PS) registration process according to the SI13 of the target cell after the CS voice service is completed.

4. The method according to claim 2, further comprising:
based on an SI13 message of the target cell not being received during the waiting, receiving an SI13 message of a cell on which the user equipment is camped after the CS voice service is completed; and
initiating a packet-switched (PSI registration process according to the SI13 message of the cell on which the user equipment is camped.

5. The method according to claim 1, wherein the system message is an SI1 message and an message SI3; and
wherein the CS voice service fallback response message carries at least one of the SI1 message and the SI3 message.

6. The method according to claim 5, wherein the CS voice service fallback response message carries one message of the SI1 message and the SI3 message, and acquiring the system message comprises:
waiting to receive the other message of the SI1 message and the SI3 message from, the GSM network; and
receiving and reading the other message of the SI1 message and the SI3 message.

7. The method according to claim 6, further comprising:
based on an SI13 message of the target cell being received during the waiting, reading and storing the SI13 message of the target cell; and
during performance of the CS voice service, based on a cell on which the user equipment camps not being switched, initiating a packet-switched (PS) registration process according to the SI13 message of the target cell after the CS voice service is completed.

8. The method according to claim 6, further comprising:
based on an SI13 message of the target cell not being received during the waiting, receiving an SI13 message of a cell on which the user equipment is camped after the CS voice service is completed; and
initiating a packet-switched (PS) registration process according to the SI13 of the cell on which the user equipment is camped.

9. The method according to claim 5, wherein the system message is acquired from the CS voice service fallback response message when the CS voice service fallback response message comprises the system message.

10. A user equipment, comprising a transmitter, a receiver, a processor and a non-transitory processor-readable medium having processor-executable instructions stored thereon: wherein the transmitter is configured to send a request message to a Long Term Evolution (LTE) network for requesting a circuit-switched (CS) voice service from the LTE network;
wherein the receiver is configured to receive a CS voice service fallback response message sent by the LTE network for instructing the user equipment to perform circuit switched fallback (CSFB) from the LTE network to a Global System for Mobile Communications (GSM) network;
wherein the processor-executable instructions include:
an acquiring unit, configured to: acquire a system message of a target cell delivered by the GSM network after the CS voice service fallback response message is received, wherein the system message comprises an SI3 message; and
a processing unit, configured to camp on the target cell according to the system message acquired by the acquiring unit, and initiate a CS registration process according to the system message for performing the CS voice service.

11. The user equipment according to claim 10, wherein the acquiring unit comprises:
a waiting subunit, configured to: after the receiving unit receives the CS voice service fallback response message wait to receive the system message of the target cell from the GSM network; and
an acquiring subunit, is-configured to receive and read the system message of the target cell.

12. The user equipment according to claim 11, wherein:
the acquiring subunit is further configured to: receive, read and store an SI13 message of the target cell during the waiting; and
the processing unit is further configured to: based on a cell on which the user equipment camps not being switched, initiate a packet-switched (PSI registration process according to the SI13 message of the target cell after the CS voice service is completed.

13. The user equipment according to claim 11, wherein:
the acquiring subunit is further configured to: based on an SI13 message of the target cell not being received during the waiting, receive and read an SI13 message of a cell on which the user equipment is camped after the CS voice service is completed; and
the processing unit is further configured to initiate a packet-switched (PS) registration process according to the SI13 message of the cell on which the user equipment is camped.

14. The user equipment according to claim 10, wherein the system message comprises an SI1 message and the an SI3 message; and
the CS voice service fallback response message carries at least one of the following message: the SI1 message and the SI3 message.

15. The user equipment according to claim 14, wherein the CS voice service fallback response message carries one message of the SI1 message and the SI3 message; and wherein the acquiring unit comprises:
a waiting subunit, configured to: after the CS voice service fallback response message is received, wait to receive the other message of the SI1 message and the SI3 message by from the GSM network, and
an acquiring subunit, configured to receive and read the other message of the SI1 message and the SI3 message.

16. The user equipment according to claim 15, wherein:
the acquiring subunit is further configured to: during the waiting, receive, read and store an SI13 message of the target cell; and
the processing unit is further configured to: based on a cell on which the user equipment camps not being switched, initiate a packet-switched (PS) registration process according to the SI13 message of the target cell acquired after the CS voice service is completed.

17. The user equipment according to claim 15, wherein:
the acquiring subunit is further configured to: based on an SI13 message of the target cell not being received during the waiting, receive and read an SI13 message of a cell on which the user equipment is camped after the CS voice service is completed; and
the processing unit is further configured to initiate a packet-switched (PS) registration process according to the SI13 message of the cell on which the user equipment is camped.

18. The user equipment according to claim 14, wherein the CS voice service fallback response message carries the system message; and
wherein the acquiring unit is configured to: acquire the system message from the CS voice service fallback response message.
